(19) United States
(12) Patent Application Publication
(10) Pub. No.: US 2009/0052646 A1
(43) Pub. Date: Feb. 26, 2009

(54) Automatic Conferencing System

(76) Inventors: John T. McGowan, Chicago, IL (US); Michael J. Fitzpatrick, Chicago, IL (US)

Correspondence Address: Michael J. Fitzpatrick, 9033 S. Hamilton Ave., Chicago, IL, 60620, US

(21) Appl. No.: 11/844,768

(22) Filed: Aug. 24, 2007

(51) Int. Cl. H04M 3/56

(52) U.S. Cl. 379/202.01

(57) ABSTRACT

A method for automatically commencing a conference call includes a computer that is connected to a telephone network. The computer automatically calls telephone numbers of conferees at a scheduled time and date and conferences together the conferees who answer their telephones. The telephone numbers and the time and date of the scheduled conference call are inputted to the computer prior to the conference call. The computer may connect conferees to one another automatically as soon as the conferees answer their telephones. Optionally, the computer may connect the conferees to one another only after the conferees choose to be connected.

### BACKGROUND OF THE INVENTION

Embodiments of the present invention generally relate to telecommunications, and more particularly, to systems, methods, and computer-readable media containing computer-executable instructions for automatically commencing conference calls.

Conference calls are typically initiated by employing a telephone conferencing service provided by a third party, such as AT&T®. Conferees are given a toll free number to call at a schedule time and date and are prompted to enter an access code after calling the toll free number. The telephone conferencing service automatically conferences together the conferees that call in and enter the access code.

Conferees wishing to participate in a scheduled conference call need to call the telephone number of the third party conferencing service and then enter an access code. Thus, conferees must remember (or be reminded) when to call in, what number to call, and what access code to enter. A need exists for a conferencing system that automatically calls the conferees at the scheduled time and date, and conferences the conferees together.

### BRIEF SUMMARY OF THE INVENTION

Certain embodiments of the present invention provide a method for automatically commencing a conference call. The method includes a computer that is connected to a telephone network. The computer automatically calls telephone numbers of conferees at a scheduled time and date and conferences together the conferees who answer their telephones.

The computer may connect conferees to one another automatically after the conferees answer their telephones. Thus, in certain embodiments of the present invention, conferees must merely answer their telephones in order to join a conference call. Optionally, however, the computer may be configured to connect conferees to one another only after the conferees choose to be connected. Each conferee can choose to be connected by entering a voice command or a keypad command in response to an audible message played by the computer.

The computer calls the conferees simultaneously or approximately simultaneously. Optionally, the computer may call the conferees at differing times to provide for a conference call of a select group of conferees prior to an expanded conference call with additional conferees. For example, the computer can call and conference together three conferees, and then, after a period of time, the computer can call ten additional conferees and conference them into the conference call already in progress.

Optionally, the computer can automatically call an alternative telephone number if an initial call to one of the conferees remains unanswered after a period of time.

Certain embodiments of the present invention also provide a system for automatically commencing a conference call. The system includes a computer that can receive and store conferee data regarding the names and telephone numbers of conferees and scheduling data regarding a time and date for when a conference call is to be commenced and the subject matter of the conference call. The computer is connected to a telephone network, allowing it to automatically dial all conferees at the scheduled time and date and conference together the conferees that answer their telephones.

Certain embodiments of the present invention also provide a computer readable medium including a set of instructions for execution on a computer that is connected to a telephone network. The instructions include a calling routine, which is capable of automatically calling telephone numbers of conferees. The instructions also include a conferencing routine, which is capable of conferencing together each conferee who answers the telephone.

### BRIEF DESCRIPTION OF SEVERAL VIEWS OF THE DRAWINGS

FIG. 1 illustrates a block diagram of a system for automatically commencing a conference call according to an embodiment of the present invention.

FIG. 2 illustrates a simplified flow diagram of a method for automatically commencing a conference call according to an embodiment of the present invention.

FIG. 3 illustrates a flow diagram of a detailed process of steps and junctures that occurs within a method for automatically commencing a conference call according to an embodiment of the present invention.

### DETAILED DESCRIPTION OF THE INVENTION

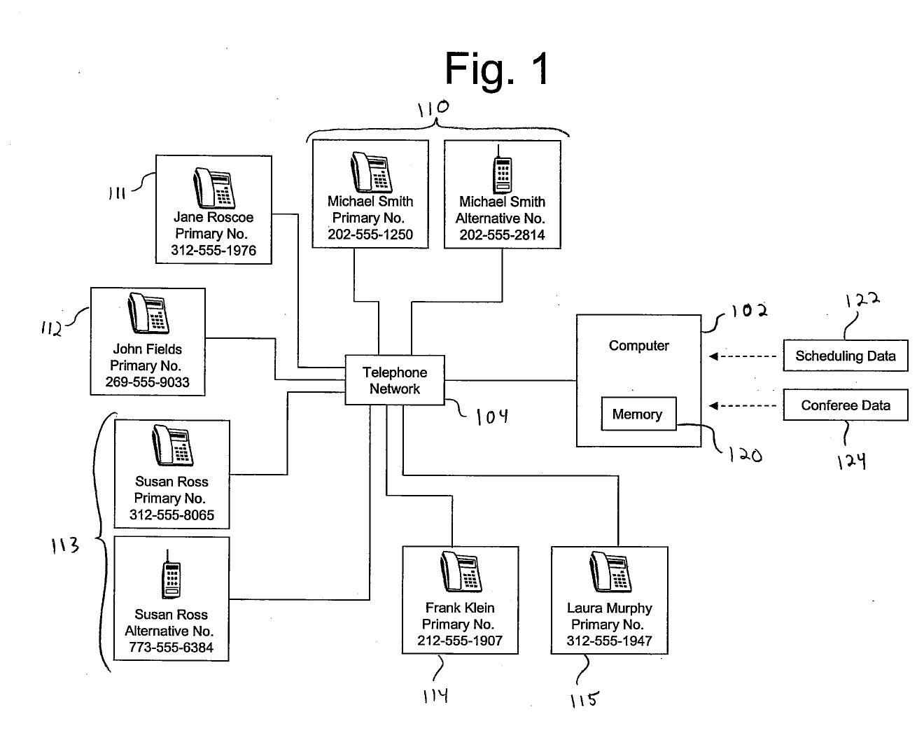

FIG. 1 illustrates a block diagram of a system for automatically commencing a conference call. More specifically, FIG. 1 illustrates a computer 102 that is connected to a telephone network 104, allowing the computer 102 to call any telephone number reachable through the telephone network 104. Interfaces between computers and telephone networks are well known in the art. In fact, modems serving as an interface between computers and telephone networks have been used widely for years. Additionally and for example only, U.S. Pat. No. 5,155,761 to Hammond, U.S. Pat. No. 4,922,520 to Bernard et al., and U.S. Pat. No. 4,748,656 to Gibbs et al., all of which are incorporated by reference, describe various interfaces between computers and telephone networks. Thus, persons of ordinary skill in the art would readily understand how to configure the computer 102 to interface with the telephone network 104 in accordance with embodiments of the present invention.

FIG. 1 also illustrates a plurality of conferees 110-115 that have been invited to the conference call. As illustrated, each of the conferees 110-115 has a primary telephone number to be used for the conference call. Additionally, some of the conferees 110 and 113 have alternative telephone numbers. For example, Conferee Susan Ross 113 has a primary telephone number of 312-555-8065 (her office telephone number) and an alternative telephone number of 773-555-6384 (her mobile telephone number). Although the computer 102 need not receive any calls in order to practice the invention, the computer 102 may have one or more of its own telephone numbers (not shown). Indeed, the computer 102 may require access to several telephone numbers in order to generate several calls simultaneously or approximately simultaneously.

The computer 102 and the conferees 110-115 are all interconnected via the telephone network 104.

The computer 102 includes a memory 120 for storing inputted scheduling data 122 and conferee data 124. The scheduling data 122 includes a time and date for when the conference call is to be commenced and also includes the subject matter of the conference call. The conferee data 124 includes the names and telephone numbers of the conferees 110-115.

The computer 102 includes software for executing instructions for the following functions:
(1) automatically generate calls to the telephone numbers of the conferees 110-115 at the scheduled time and date,
(2) play a short prerecorded message to each of the conferees 110-115 that answers the telephone, and
(3) conference together each of the conferees 110-115 that elects to join the conference call.
   It will be appreciated and understood by persons of ordinary skill in the art how to write software to carry out the above-specified functions. Indeed, it is an axiom of computer programming that once a function is specified, one can readily write a software instruction to carry out the function.

With respect to FIG. 1, the scheduling data 122 and conferee data 124 may be inputted to the computer 102 via any known conventional means. Although not illustrated, the means for inputting the scheduling data 122 and conferee data 124 include using a keyboard that is directly connected to the computer 102, loading a compact disc or other portable media into the computer 102, and transmitting information to the computer 102 over an intranet or the Internet via, for example, email or an interactive website. After inputted to the computer 102, the scheduling data 122 and conferee data 124 are stored to the memory 120.

When the date and time specified in the scheduling data 122 occurs, the computer 102 automatically generates calls to the conferees 110-115 at the primary telephone numbers specified in the conferee data 124. The calls can be generated simultaneously or approximately simultaneously.

When a conferee answers the call, a short prerecorded message is played, which announces the subject matter of the conference call and which instructs the conferee how to join the conference call. If the subject matter of the conference call as specified in the scheduling data 122 is, for example, the budget for the Vandelay Industries project, then the prerecorded message could state the following:
You are being asked to attend the previously scheduled conference call regarding [budget for Vandelay Industries project]. Press 1 on your keypad to join this conference call.

If the conferee elects to join the conference call by pressing the “1” button, the conferee is automatically conferenced together with the other conferees who elect to join the conference call.

If the conferee does not answer the call to his or her primary telephone number within a predetermined period of time t₁, the computer 102 will then generate a second call to an alternative telephone number if one is available. For example, if Conferee Susan Ross 113 does not answer a call to her office telephone at 312-555-8065 within time t₁, the computer 102 will then generate a second call to her mobile telephone at 773-555-6384.

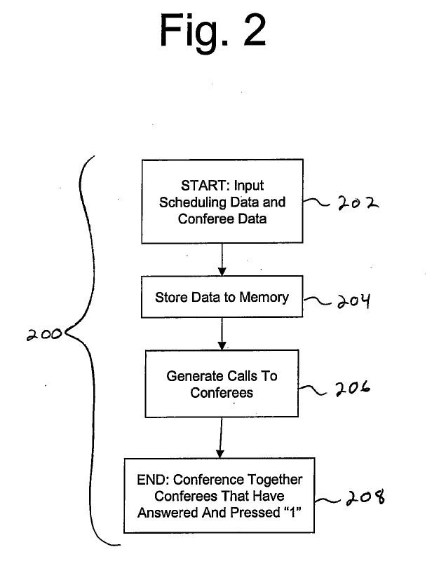

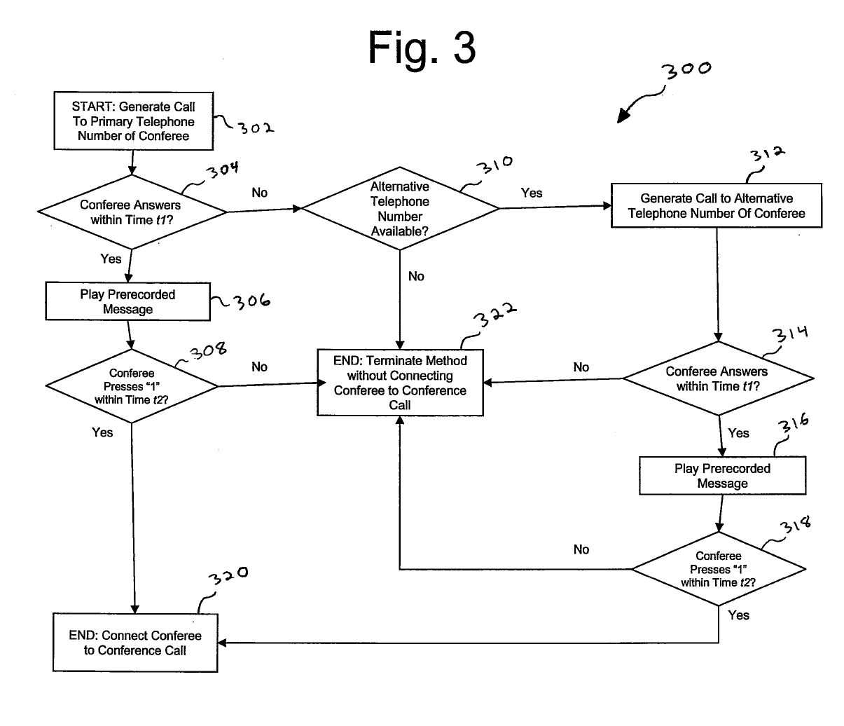

FIG. 2 illustrates a simplified flow diagram of a method for automatically commencing a conference call 200, comprising steps 202 through 208 (odd numbers excluded) that can be carried out using the computer 102 illustrated in FIG. 1. The method 200 begins at step 202 when the scheduling data 122 and conferee data 124 are inputted into the computer 102. The method 200 then proceeds to step 204 in which the data is stored to the computer's memory 120. Step 206 commences when the time and date specified in the scheduling data 122 occurs. In step 206, the computer 102 generates calls to the telephone numbers of the conferees 110-115 specified in the conferee data 124. In step 208, the computer 102 conferences together all of the conferees 110-115 that have answered the telephone and elected to join the conference call. Steps 206 and 208 are simplified in the illustration of FIG. 2. Reference to FIG. 3, however, will help in understanding how steps 206 and 208 are carried out in further detail.

FIG. 3 illustrates a flow diagram of a detailed process 300 of steps and junctures 302-322 (odd numbers excluded) that occurs with respect to each of the conferees 110-115 during the simplified steps 206 and 208 of FIG. 2. Hence, the process 300 occurs multiple times in parallel, one time for each conferee.

The process 300 originates at step 302. Step 302 begins when the time and date specified in the scheduling data 122 occurs. During step 302, the computer 102 generates a call to the primary telephone number of one of the conferees 110-115. If the conferee answers the call within time t₁, the process 300 proceeds through juncture 304 to step 306.

In step 306, the computer 102 transmits a prerecorded message to the telephone of the conferee. The prerecorded message announces the subject matter of the conference call (which was specified in the scheduling data 122) and instructs the conferee to press “1” on the keypad in order to join the conference call. For example, the prerecorded message could state the following:
You are being asked to attend the previously scheduled conference call regarding [budget for Vandelay Industries project]. Press 1 on your keypad to join this conference call.
   If the conferee presses the “1” button before a predetermined period of time t₂ elapses, the process 300 proceeds through juncture 308 to step 320. In step 320, the conferee is connected to the conference call, and the process 300 completes with respect to that conferee.

If, however, at juncture 304, the conferee does not answer the call within time t₁, the process 300 proceeds to juncture 310. At juncture 310, the computer 102 determines whether an alternative telephone number for the conferee is provided by the conferee data 124. If there is an alternative telephone number available, the process 300 proceeds to step 312, during which the computer 102 generates a call to the alternative telephone number. If the conferee answers the call within time t₁, the process 300 proceeds through juncture 314 to step 316.

In step 316, the computer 102 transmits to the telephone of the conferee the same prerecorded message described above. As mentioned above, the prerecorded message announces the subject matter of the conference call and instructs the conferee to press “1” on the keypad in order to join the conference call. If the conferee presses the “1” button before time t₂ elapses, the process 300 proceeds through juncture 318 to step 320. As mentioned above, in step 320, the conferee is connected to the conference call, and the process 300 is complete with respect to that conferee.

If, however, at juncture 314, the conferee does not answer the call within time t₁, the process 300 proceeds to step 322 at which the process 300 terminates without connecting the conferee to the conference call. Similarly, if the process 300 reaches juncture 310 and the conferee data 124 does not provide an alternative telephone number for the conferee, the process 300 proceeds to step 322 and terminates without connecting the conferee to the conference call. Additionally, if the process 300 reaches either of junctures 308 and 318 and the conferee fails to press the “1” button within time t₂, the process 300 proceeds to step 322 and terminates without connecting the conferee to the conference call.

After the process 300 completes with respect to each of the conferees 110-115, all of the conferees 110-115 that have timely answered the telephone and timely elected to join the conference call will have automatically been connected with one another.

It is appreciated and understood by persons of ordinary skill in the art that computers can be configured to automatically generate telephone calls. For example, U.S. Pat. No. 5,155,761 to Hammond describes a controller configured to automatically call telephone numbers without human intervention.

It is appreciated and understood by persons of ordinary skill in the art how to configure computers to greet a person who answers an automatically-generated telephone call with an automated message and to receive and process an instruction from the person. For example, U.S. Pat. No. 5,155,761 to Hammond describes a controller configured to play an automated message to a person on the other end of a telephone connection and to receive and process an instruction from the person.

It is appreciated and understood by persons of ordinary skill in the art how to configure computers to automatically conference multiple telephone calls together after specified criteria are met, as is done by conferencing services currently provided by third parties, such as AT&T®.

It has not previously been appreciated or understood, however, that a computer can be configured to do the above functions in the combinations described by the present specification to automatically commence a conference call without any of the conferees having to dial a telephone number.

Because the conferees 110-115 are called by the computer 102 at the telephone numbers that were previously inputted to the computer 102, an access code is not necessary. However, certain embodiments of the present invention may employ access codes for added security.

It should be understood that times t₁ and t₂ are adjustable according to preference.

It should be understood that configuring a computer within the meaning of this specification may include configuring computer hardware, software, firmware, and accessories. For example, configuring a computer to interface with a telephone network in accordance with the present invention may require a computer with certain minimum capabilities, a modem, and software or firmware containing appropriate instructions.

The term “telephone network” as used in this specification is not limited to a network consisting only of landlines. The term “telephone network” refers to any network through which a call to a telephone can be made, regardless of how the call is transmitted. Thus, the term “telephone network” refers to calls made through, for example, traditional landlines, fiber optic cables (e.g., over the Internet), satellites, and cell towers.

While certain embodiments of the present invention employ audio only conference calls, other embodiments may employ expanded types of conference calls, such as webinars and video teleconferences. Thus, it should be understood that embodiments of the present invention may be used in conjunction with webinars, video teleconferences, and the like.

While certain embodiments of the present invention employ the above-described prerecorded message, other embodiments may include other prerecorded messages that provide for further options than simply pressing the “1” button to join the conference call. For example, an alternative prerecorded message could instruct a conferee to press “2” to enter an alternative telephone number at which he can be immediately reached (in case the telephone number at which he is initially called turns out to be inconvenient).

While certain embodiments of the present invention employ conferee data and scheduling data for a single group of conferees and a single date and time for a conference call to be commenced, other embodiments may include more detailed data to facilitate a staggered conference call. For example, the computer could call the conferees at differing times to provide for a conference call of a select group of conferees prior to an expanded conference call with additional conferees. More specifically, for example, the computer could call three conferees and conference them together, and then, after a period of time, the computer could call ten additional conferees and conference them into the conference call already in progress.

While certain embodiments of the present invention employ a computer that connects a conferee to the conference call only after he elects to join the conference call, other embodiments may employ computers that connect a conferee to the conference call if he merely answers the telephone and remains on the line. For example, a computer could play the following prerecorded message to each conferee upon answering the telephone:
You were previously scheduled to participate in today's conference call regarding [budget for Vandelay Industries project]. At the tone, you will be connected to the conference call.
   Subsequently, the computer could sound a tone and connect the conferee to the conference call.

While certain embodiments of the present invention employ keypad commands such as pressing “1” to join a conference call, other embodiments may employ other types of commands, including voice commands.

While certain embodiments of the present invention employ U.S. telephone numbers only, other embodiments may employ international telephone numbers.

While certain embodiments of the present invention employ methods for automatically commencing conference calls, other embodiments may employ systems for automatically commencing conference calls.

While certain embodiments of the present invention employ methods for automatically commencing conference calls, other embodiments may employ computer readable media including computer-executable instructions for automatically commencing conference calls. For example, the instructions could include the following routines:
(1) a calling routine, which is capable of automatically calling the telephone numbers of conferees;
(2) an announcement routine, which is capable of providing a prerecorded message to each conferee who answers the telephone;
(3) an interactive routine capable of receiving and processing a conferee's command to join the conference call; and
(4) a conferencing routine, which is capable of conferencing together each conferee who answers his telephone and elects to join the conference call.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

We claim:

1. A method of initiating a conference call, comprising a computer that is connected to a telephone network, said computer automatically generating an initial call to each of a plurality of primary telephone numbers, said computer conferencing together at least two of said calls.

2. The method of initiating a conference call of claim 1, in which said computer automatically generates an initial call to each of said primary telephone numbers simultaneously.

3. The method of initiating a conference call of claim 1, in which said computer automatically generates an initial call to each of said primary telephone numbers approximately simultaneously.

4. The method of initiating a conference call of claim 1, in which said computer automatically generates an initial call to each of said primary telephone numbers at a previously scheduled time.

5. The method of initiating a conference call of claim 1, in which said conferencing is automatic.

6. The method of initiating a conference call of claim 1, in which said conferencing is configured to require a command transmitted from a conferee who answers one of said initial calls.

7. The method of initiating a conference call of claim 1, in which said computer automatically generates a secondary call to an alternative telephone number if one of said initial calls remains unanswered after a period of time, said computer conferencing together said secondary call and at least one of said initial calls.

8. A computer-readable medium including a set of instructions for execution on a computer that is connected to a telephone network, the set of instructions comprising:
an initial calling routine capable of automatically generating initial calls to a plurality of primary telephone numbers; and
a conferencing routine capable of conferencing together at least two of said initial calls.

9. The computer-readable medium of claim 8, further comprising:
an announcement routine capable of providing a prerecorded message to a conferee that answers one of said initial calls.

10. The computer-readable medium of claim 8, further comprising:
an announcement routine capable of providing a prerecorded message to a conferee that answers one of said initial calls, said message comprising information regarding how to join a conference call.

11. The computer-readable medium of claim 8, further comprising:
an interactive routine capable of receiving and processing an instruction from a conferee that answers one of said initial calls.

12. The computer-readable medium of claim 11, wherein said instruction is an instruction to connect said conferee to a conference call.

13. The computer-readable medium of claim 11, wherein said instruction is an instruction to call said conferee at an alternative telephone number.

14. The computer-readable medium of claim 8, further comprising:
a pre-conference call routine capable of receiving inputted scheduling data and conferee data, said scheduling data comprising information regarding when said calling routine is to be executed, and said conferee data comprising at least two of said primary telephone numbers.

15. The computer-readable medium of claim 8, further comprising:
a secondary calling routine capable of automatically generating a secondary call to an alternative telephone number if a specified criterion is met, wherein said conferencing routine is capable of conferencing together said secondary call and at least one of said initial calls.

16. The computer-readable medium of claim 8, further comprising:
a secondary calling routine capable of automatically generating a secondary call to an alternative telephone number if one of said initial calls remains unanswered after a period of time, wherein said conferencing routine is capable of conferencing together said secondary call and at least one of said initial calls.

17. A system for carrying out a conference call comprising:
a computer that is connected to a telephone network, said computer configured to automatically generate calls to a plurality of telephone numbers at a previously scheduled time and date, said computer configured to conference together two of said calls.

18. The system for carrying out a conference call of claim 17 wherein said computer is configured to conference together two of said calls only after receiving a command transmitted from a conferee who answers one of said two calls.

19. The system for carrying out a conference call of claim 17 wherein said computer is configured to conference together two of said calls automatically after each of said two calls is answered.

20. The system for carrying out a conference call of claim 17 wherein said computer is configured to provide a prerecorded message to each conferee that answers one of said two calls.
